(19) United States
(12) Patent Application Publication
(10) Pub. No.: US 2008/0196192 A1
(43) Pub. Date: Aug. 21, 2008

(54) CONTRACTIBLE WINDSHIELD WIPER STRUCTURE

(76) Inventor: MIN-LI YAO, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/031,592

(22) Filed: Feb. 14, 2008

(30) Foreign Application Priority Data
Feb. 16, 2007 (CN) 200720067452.7

(51) Int. Cl. B60S 1/32

(52) U.S. Cl. 15/250.46

(57) ABSTRACT

A contractible windshield wiper structure includes: a rack; two contractible units movably and separately installed at both ends of the rack, and each contractible unit having a fixed rod; a sliding rod movably sheathed onto the fixed rod, and a bow-shaped clamping device installed separately at the fixed rod and an end of the sliding rod; and a blade installed onto the bow-shaped clamping device of each contractible unit, such that each contractible unit can be used for adjusting a windshield wiper to the required size to fit different models of cars.

### FIELD OF THE INVENTION

The present invention relates to a contractible windshield wiper structure, and more particularly to a windshield wiper that uses contractible units to achieve the effects of adjusting the windshield wiper to a required size to fit different models of cars.

### BACKGROUND OF THE INVENTION

A traditional windshield wiper generally consists of a rack, a bow-shaped clamp disposed on the rack, and a blade installed onto the bow-shaped clamp, and the windshield wiper is connected to the rack of a windshield wiper of a car, and the rack drives the blade of the windshield wiper to wipe rain and water from a windshield of the car.

Although the aforementioned traditional windshield wiper can be installed to a car for wiping rain from the windshield, the windshield wiper usually comes with a fixed size (such as 14 inches, 16 inches and 23 inches, etc) to fit a certain model of cars. Manufactures and distributors have to manufacture and prepare spare parts for the windshield wipers in different sizes and specifications, and thus the prior art not only carries a large inventory and wastes lots of storage spaces, but also causes an issue of providing a particular windshield wiper with compatible size or specification when the windshield wipers of such size are sold out or phased out, since the windshield wipers of different sizes cannot be shared. Obviously, the prior art cannot meet consumer requirements.

### SUMMARY OF THE INVENTION

In view of the foregoing shortcomings of the prior art, the inventor of the present invention based on years of experience in the related field to conduct extensive researches and experiments, and finally developed a contractible windshield wiper structure in accordance with the present invention to overcome the shortcomings of the prior art.

Therefore, it is a primary objective of the present invention to provide a contractible windshield wiper structure that uses contractible units to achieve the effects of adjusting the windshield wiper to a required size to fit different models of cars.

To achieve the foregoing objective, the present invention provides a contractible windshield wiper structure comprising: a rack; two contractible units movably and respectively installed at both ends of the rack, each contractible unit comprising a fixed rod, a sliding rod movably sheathed onto the fixed rod, and a bow-shaped clamping device installed separately at the fixed rod and an end of the sliding rod; and a blade installed onto the bow-shaped clamping device of each contractible unit.

### BRIEF DESCRIPTION OF THE DRAWINGS

FIG. 1 is a perspective view of a first preferred embodiment of the present invention;

FIG. 2 is an exploded view of a first preferred embodiment of the present invention;

FIG. 3 is a schematic view of a fixed rod in accordance with a first preferred embodiment of the present invention;

FIG. 4 is a schematic view of a sliding rod in accordance with a first preferred embodiment of the present invention;

FIG. 5 is a schematic view of a fixed rod in accordance with a second preferred embodiment of the present invention;

FIG. 6 is a schematic view of a sliding rod in accordance with a second preferred embodiment of the present invention;

FIG. 7 is a schematic view of a contractible unit in accordance with a second preferred embodiment of the present invention;

FIG. 8 is a schematic view of a fixed rod in accordance with a third preferred embodiment of the present invention;

FIG. 9 is a schematic view of a sliding rod in accordance with a third preferred embodiment of the present invention;

FIG. 10 is a schematic view of a contractible unit in accordance with a third preferred embodiment of the present invention;

FIG. 11 is an exploded view of a fourth preferred embodiment of the present invention; and

FIG. 12 is an exploded view of a fifth preferred embodiment of the present invention.

### DESCRIPTION OF THE PREFERRED EMBODIMENT

The above and other objects, features and advantages of the present invention will become apparent from the following detailed description taken with the accompanying drawing.

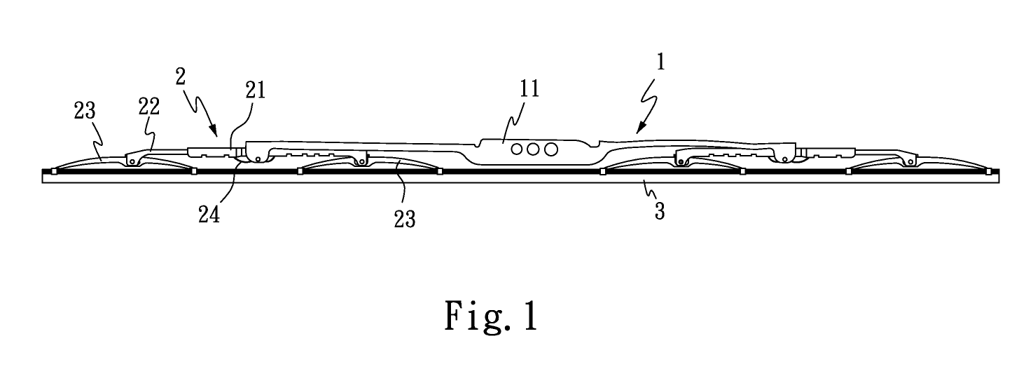

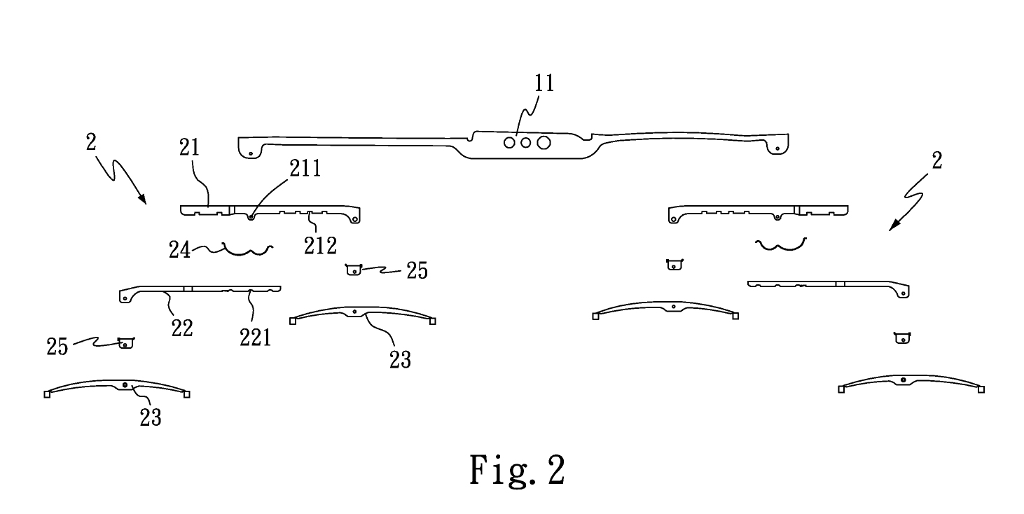

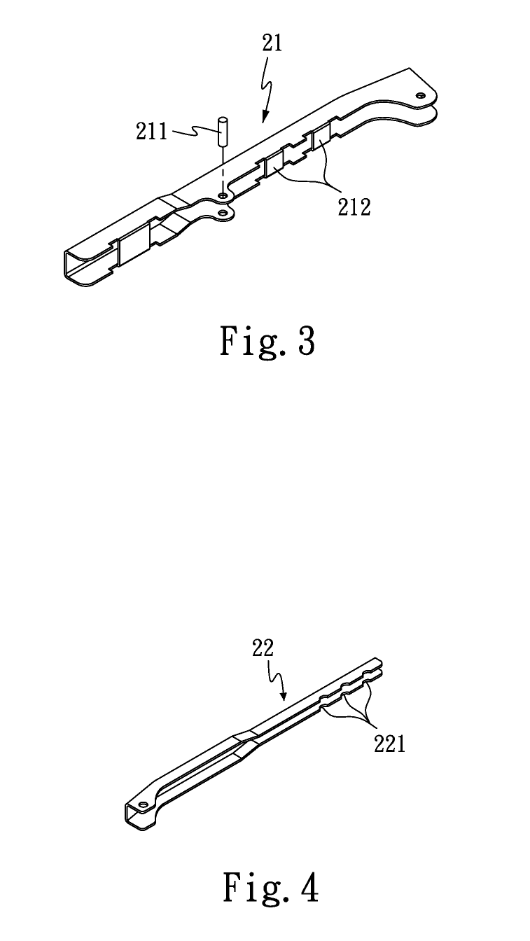

Referring to FIGS. 1 to 4 for a perspective view of a first preferred embodiment of the invention, an exploded view of a first preferred embodiment of the invention, a schematic view of a fixed rod of a first preferred embodiment of the invention, and a schematic view of a sliding rod of a preferred embodiment of the present invention respectively, the invention provides a contractible windshield wiper structure comprising a rack 1, two contractible unit 2 and a blade 3.

The rack 1 includes a connecting portion 11 at the middle of the rack 1 for connecting an arm (not shown in the figure) of the windshield wiper of a car.

Each contractible unit 2 is movably and separately installed on both ends of the rack 1 and each contractible unit 2 comprises a fixed rod 21, a sliding rod 22 movably sheathed onto the fixed rod 21, and a bow-shaped clamping device 23 disposed separately at the fixed rod 21 and an end of the sliding rod 22, wherein each fixed rod 21 includes a rack 1 disposed at an appropriate position and movably coupled to the pivot 211, and a surface of the fixed rod 21 includes a plurality of stop plates 212, and a surface of the sliding rod 22 includes a plurality of positioning notches 221, and the pivot 211 of the fixed rod 21 includes a resilient plate 24 of the positioning notch 221 for propping and pressing the sliding rod 22, and a shock absorbing element 25 installed between each fixed rod 21 and the sliding rod 22, and between each fixed rod 21 and the bow-shaped clamping device 23.

The blade 3 is installed on the bow-shaped clamping device 23 of each contractible unit 2. The aforementioned structure constitutes a novel contractible windshield wiper structure.

If it is necessary to adjust the size of the windshield wiper according to the invention, the sliding rod 22 of each contractible unit 2 is pulled directly to a side, such that the sliding rod 22 is extended to or retracted from the fixed rod 21. In the meantime, each positioning notch 221 of the sliding rod 22 props and slides on the resilient plate 24, such that the sliding rod 22 can be moved and fixed to the required position, and each contractible unit 2 is used for adjusting the required size of the windshield wiper to fit different models of cars.

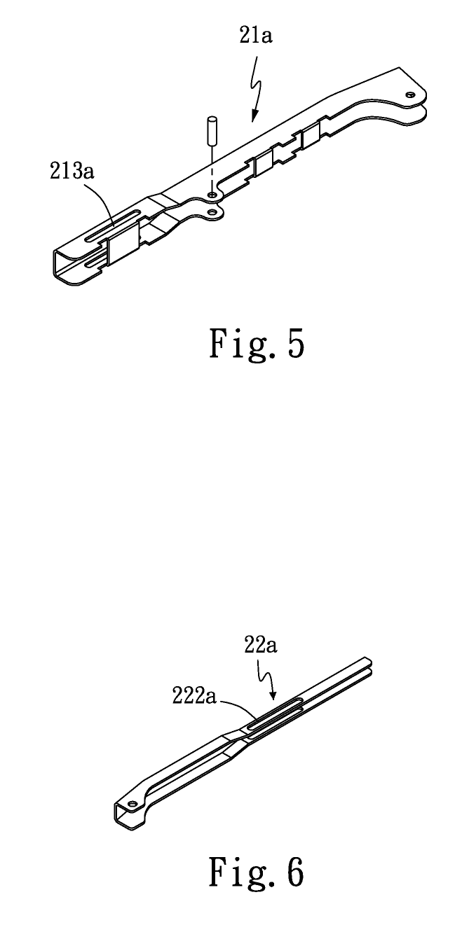

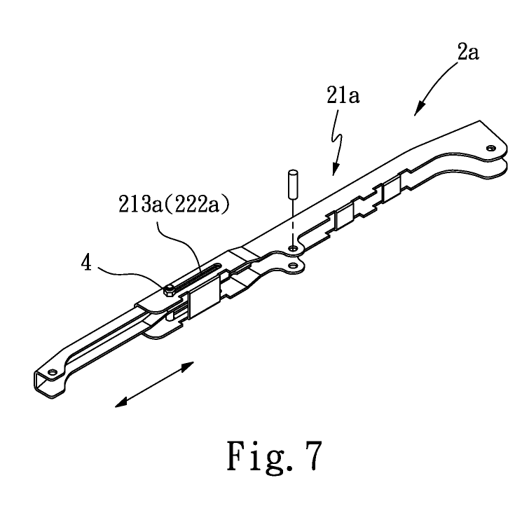

Referring to FIGS. 5 to 7 for schematic views of a fixed rod of a second preferred embodiment of the invention, a sliding rod of a second preferred embodiment of the invention, and a contractible unit of a second preferred embodiment of the invention respectively, the fixed rod 21a of each contractible unit 2 includes a corresponding slide slot 213a in accordance with the first preferred embodiment of the present invention in addition to the aforementioned structure, and both sides of the sliding rod 22a separately have a corresponding slot 222a corresponding to the slide slot 213a, and a fixing element 4 is passed through the slide slot 213a and the corresponding slot 222a.

When the size of the windshield wiper is adjusted, the sliding rod 22a of each contractible unit 2a is pulled directly to a side, such that the sliding rod 22a is extended to or retracted from the fixed rod 21a. In the meantime, the slide slot 222a of the sliding rod 22a together with the corresponding slot 222a slide on the fixing element 4, such that each contractible unit 2a can be used for adjusting the required size of the windshield wiper to fit different models of cars.

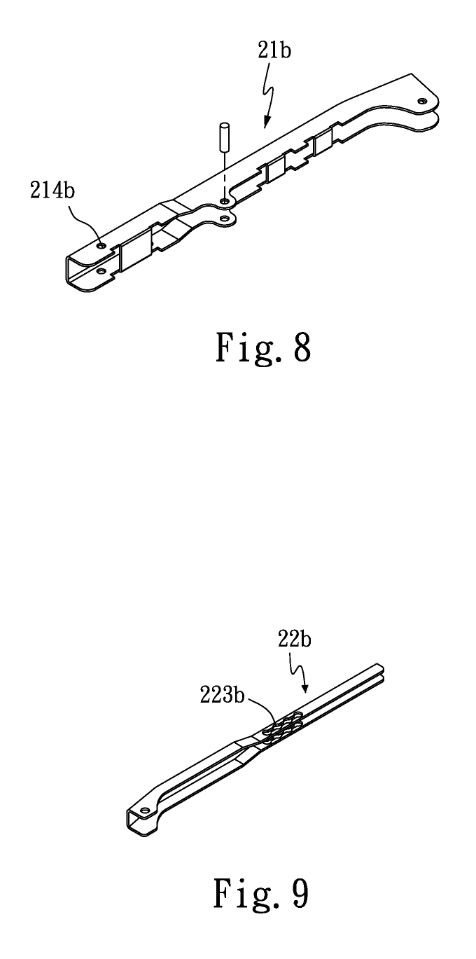

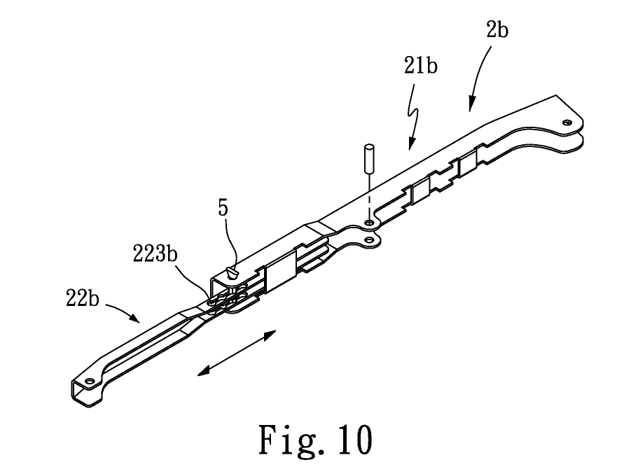

Referring to FIGS. 8 to 10 for a schematic view of a fixed rod of a third preferred embodiment of the invention, a schematic view of a sliding rod of a third preferred embodiment of the invention, and a schematic view of a contractible unit of a third preferred embodiment of the invention respectively, the fixed rod 21b of each contractible unit 2b includes a corresponding through hole 214b disposed at an appropriate position in addition to each contractible unit 2, 2a with the aforementioned structures in accordance with the first and second preferred embodiments of the present invention, and both sides of the sliding rod 22b have a groove hole 223b corresponding to the through hole 214b, and a pin 5 is passed through the through hole 214b and the groove hole 223b.

When the size of the windshield wiper is adjusted, the sliding rod 22b of the each contractible unit 2b is pulled directly to a side, such that the sliding rod 22b is extended to or retracted from the fixed rod 21b. In the meantime, the groove hole 223b of the sliding rod 22b slides on the pin 5, so that each contractible unit 2b can be used for adjusting the required size of the windshield wiper to fit different models of cars.

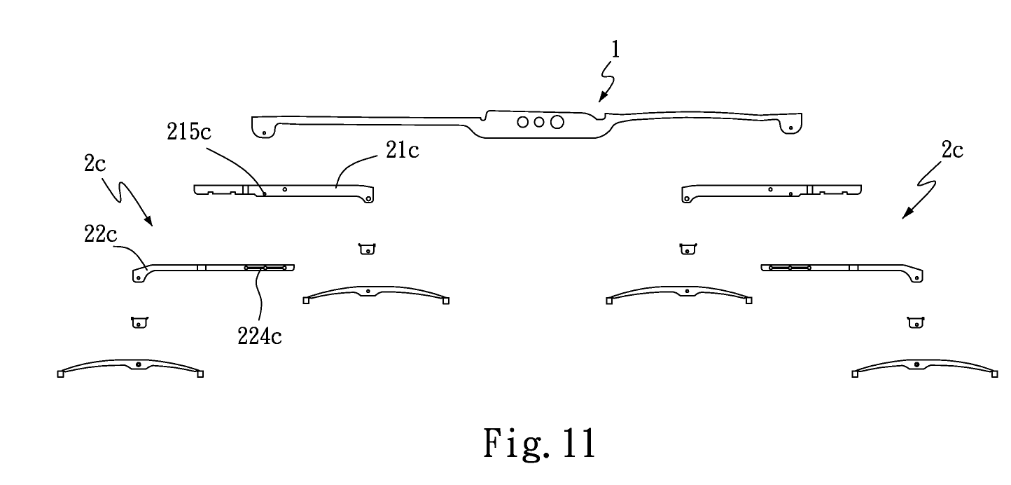

Referring to FIG. 11 for an exploded view of a fourth preferred embodiment of the present invention, the fixed rod 21c of each contractible unit 2c includes a transverse rod 215c disposed at an appropriate position, and both sides of the sliding rod 22c includes a slide slot 224c sheathed onto the transverse rod 215c, in addition to each contractible unit 2, 2a, 2b with the structures as shown in the first, second and third embodiments of the invention.

When the size of the windshield wiper is adjusted, the sliding rod 22c of each contractible unit 2c is extended to or retracted from the fixed rod 21c. In the meantime, the slide slots 224c on both sides of the sliding rod 22a slide on the transverse rod 215c of the fixed rod 21c, such that the sliding rod 22c is moved and fixed to the required position, and each contractible unit 2c can be used for adjusting the required size of the windshield wiper to fit different models of cars.

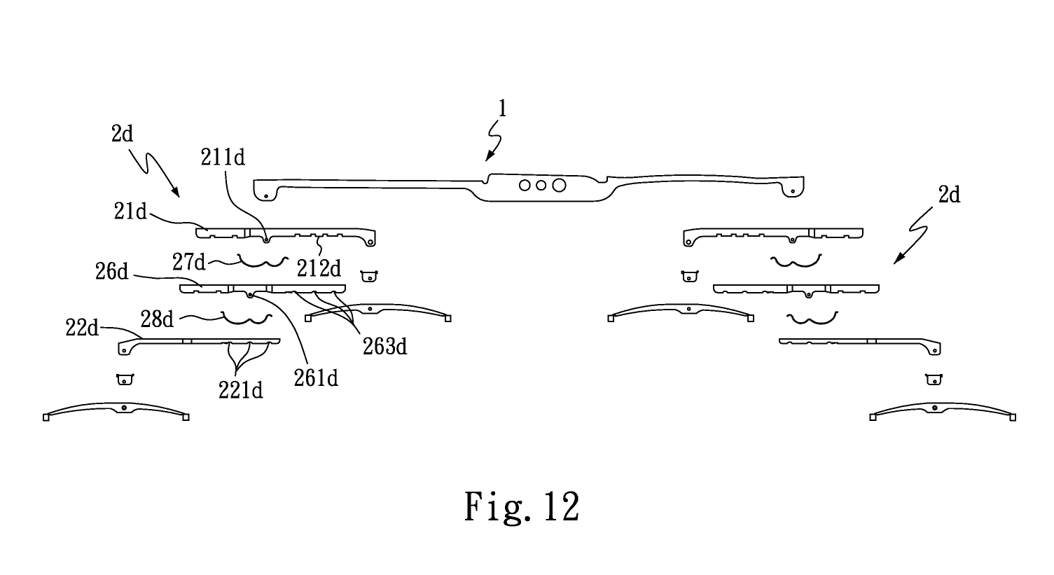

Referring to FIG. 12 for an exploded view of a fifth preferred embodiment of the present invention, each contractible unit 2d includes a fixed rod 21d, a link rod 26d and a sliding rod 22d sheathed and connected with each other, in addition to each contractible unit 2, 2a, 2b, 2c in accordance with the first, second, third and fourth embodiment of the present invention, and a pivot 211d, 261d is installed at an appropriate position between the fixed rod 21d and the link rod 26d, and a surface of the fixed rod 21d includes a plurality of stop plates 212d, and a surface of both sides of the pivot 261d of the link rod 26d includes a plurality of stop plates 262d and positioning notches 263d, and a surface of the sliding rod 22d includes a plurality of positioning notches 221d, and the pivot 211d of the fixed rod 21d includes a first resilient plate 27d propped and pressed at the positioning notch 263d of the link rod 26d, and the pivot 261d of the link rod 26d includes a second resilient plate 28d propping and pressing at the positioning notch 221d of the sliding rod 22d.

When the size of the windshield wiper is adjusted, a sliding rod 22d of each contractible unit 2d extends or retracts the link rod 26d, and the link rod 26d extends or retracts the fixed rod 21d. In the meantime, the positioning notch 263d of the link rod 26d props and slides on the first resilient plate 27d, and each positioning notch 221d of the sliding rod 22d props and slides on the second resilient plate 28d, so that the sliding rod 22d and the link rod 26d are moved and fixed to the required positions, and each contractible unit 2d is used for adjusting the required size of the windshield wiper to fit different models of cars.

In summation of the description above, the contractible windshield wiper structure of the invention effectively overcomes the shortcomings of the prior art by using contractible units to adjust the windshield wiper to a required size to fit different models of cars, and the invention further complies with the requirements of patent application, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A contractible windshield wiper structure, comprising:
a rack;
two contractible units, movably and respectively installed on both ends of said rack, and said each contractible unit comprising a fixed rod, a sliding rod movably sheathed onto said fixed rod, and a bow-shaped clamping device installed separately at said fixed rod and an end of said sliding rod; and
a blade, installed on said bow-shaped clamping device of each contractible unit.

2. The contractible windshield wiper structure of claim 1, wherein said rack includes a connecting portion disposed at the middle of said rack.

3. The contractible windshield wiper structure of claim 1, wherein said fixed rod of each contractible unit includes a pivot disposed at an appropriate position and movably coupled to said rack, and a surface of said fixed rod includes a plurality of stop plates, and a surface of said sliding rod includes a plurality of positioning notches, and said pivot of said fixed rod includes a resilient plate of said positioning notch that props and presses against said sliding rod.

4. The contractible windshield wiper structure of claim 1, wherein said fixed rod of said each contractible unit includes a corresponding slide slot disposed at an appropriate position, and said sliding rod includes a corresponding slot disposed separately on both sides of said sliding rod and corresponding to said slide slot, and a fixing element is passed through said slide slot and said corresponding slot.

5. The contractible windshield wiper structure of claim 1, wherein said fixed rod of each contractible unit includes a corresponding through hole, and said sliding rod includes a groove hole disposed at an appropriate position and corresponding to said through hole, and said through hole includes a pin passed through said groove hole.

6. The contractible windshield wiper structure of claim 1, wherein said fixed rod of each contractible unit includes a transverse rod disposed at an appropriate position, and both sides of said sliding rod separately have a slide slot sheathed onto said transverse rod.

7. The contractible windshield wiper structure of claim 1, wherein each contractible unit includes said fixed rod, a link rod and said sliding rod, and a pivot is installed separately at appropriate positions of said fixed rod and said link rod, and a surface of said fixed rod includes a plurality of stop plates, and surfaces on both sides of said link rod separately include a plurality of stop plates and positioning notches, and a surface of said sliding rod includes a plurality of positioning notches, and said pivot of said fixed rod includes a first resilient plate propping and pressing at said positioning notch, and said pivot of said link rod includes a second resilient plate propping and pressing at said positioning notch of said sliding rod.

8. The contractible windshield wiper structure of claim 1, further comprising a shock absorbing element installed between each fixed rod and said bow-shaped clamping device.

9. The contractible windshield wiper structure of claim 1, further comprising a shock absorbing element installed between sliding rod and said bow-shaped clamping device.
